(19) United States
(12) Patent Application Publication
(10) Pub. No.: US 2026/0195835 A1
(43) Pub. Date: Jul. 9, 2026

(54) METHOD AND DEVICE FOR THE TECHNICAL CONFIGURATION OF A TRACK-BOUND VEHICLE

(71) Applicant: Siemens Mobility GmbH, München (DE)

(72) Inventors: Wolfgang Rössler, Nürnberg (DE); Norbert Heimann, Forchheim (DE); Andreas Winzen, Nürnberg (DE)

(21) Appl. No.: 19/131,019

(22) PCT Filed: Nov. 6, 2023
(86) PCT No.: PCT/EP2023/080812

§ 371 Date: May 19, 2025

(30) Foreign Application Priority Data
Nov. 17, 2022 (DE) 10 2022 212 270.4

(51) Int. Cl. G06Q 50/18; B61B 1/00; G06Q 50/04

(52) U.S. Cl. CPC G06Q 50/188; B61B 1/00; G06Q 50/04

(57) ABSTRACT

A system and a determination device for the technical configuration of a track-bound vehicle, and a production method for producing a track-bound vehicle, as well as a computer program, and a device for providing the computer program. In order to improve the configuration of the track-bound vehicle, requirement information, which represents requirements placed on the desired track-bound vehicle, is provided. Furthermore, platform information, which represents features of a vehicle platform, is provided and solution information, which represents a vehicle solution for at least partially meeting the requirements, is determined. The solution information is determined using the platform information on the basis of the requirement information.

Independent of the grammatical term usage, individuals with male, female or other gender identities are included within the term.

The invention relates to a method, a system and an ascertaining facility for the technical configuration of a track-bound vehicle. The invention also relates to a manufacturing method for manufacturing a track-bound vehicle. The invention also relates to a computer program and a supply apparatus for the computer program.

Basically it is known that invitations for bids with the purpose of awarding a contract for the development and manufacture of a track-bound vehicle substantially consist, from a technical point of view, of a list of requirements. The requirements are drawn up by a vehicle customer, for example an operator of a transportation system. A potential contractor responds to the invitation for bids with a proposal. The proposal substantially consists of commenting on the respective requirements in that, for example for one of the requirements respectively, it is indicated whether and, if so, in what manner it will be met by the proposal.

Against this background it is an object of the invention to improve the technical configuration of a track-bound vehicle.

This object is achieved by a method for the technical configuration of a track-bound vehicle, in which requirement information, which represents requirements placed on a desired track-bound vehicle, is supplied.

Platform information is supplied which represents features of a vehicle platform. Solution information, which represents a vehicle solution in order to at least partially meet the requirements, is ascertained. The solution information is ascertained using the platform information on the basis of the requirement information.

The invention is based on the recognition that the response to invitations for bids is frequently an individual solution to meet the requirements in that a response is made to the respective requirements and a track-bound vehicle which is to be proposed is developed on this basis. This is connected with high expenditure and extensive human intellectual activity for the vehicle manufacturer (the bidder). This procedure proves to be particularly disadvantageous if the vehicle manufacturer is not awarded the contract and the vehicle customer inviting bids accepts an alternative proposal from a competitor instead. The expense invested in the proprietary proposal and the resulting solutions cannot then be used again, or can only be used again to a lesser extent.

The inventive solution remedies these problems in that a response is made to an invitation for bids on the basis of existing vehicle platforms. In this way, existing vehicle solutions can be used for ascertaining the vehicle solution. In addition, the identification of a solution may be automated, at least in part, because the requirements can be systematically and comprehensibly assigned to features of an existing vehicle platform.

A further fundamental advantage of the inventive solution is that specifications, implementations and evidence already exist, can be found and reused for the features of the existing vehicle platform. For example, the approval process for the proposed vehicle can consequently be significantly shortened.

The inventive method is preferably a computer-implemented method.

The technical configuration preferably serves as a basis for the manufacture of the track-bound vehicle.

The requirement information is preferably supplied by means of a first supply facility. The first supply facility comprises, for example, a computing facility. The requirement information is transmitted, for example via the World Wide Web, to a computing facility of the vehicle manufacturer in order to be processed there.

The wording “desired track-bound vehicle” should preferably be taken to mean a track-bound vehicle which is to be proposed by a vehicle manufacturer in the framework of an invitation for bids for the awarding of a contract to develop the desired track-bound vehicle. The track-bound vehicle is accordingly desired by the vehicle customer. The requirement information is accordingly a technical representation of the invitation for bids.

The platform information is preferably supplied by means of a second supply facility which is operated by a vehicle manufacturer. The second supply facility comprises, for example, a computing facility. The platform information is accordingly a technical representation of the existing vehicle platform of the vehicle manufacturer.

The solution information is ascertained, for example, by means of an ascertaining facility which is operated by the vehicle manufacturer. The ascertaining facility also preferably comprises a computing facility.

A person skilled in the art understands the wording, according to which the solution information is ascertained using the platform information on the basis of the requirement information, such that the requirement information forms the basis for ascertaining the solution information and the platform information creates the boundary conditions for ascertaining the solution information. The aim in this case is to at least partially meet the requirements by using the possibilities which are specified by the vehicle platform. The solution information is accordingly a technical representation, at least in a first iteration, of the proposal which the vehicle manufacturer delivers in the framework of the invitation for bids.

One possible result of the ascertainment is that the vehicle solution completely meets the requirements.

According to a preferred embodiment of the inventive method, the solution information is generated by configuration of selectable and/or parameterizable features of the vehicle platform.

Further preferably, the requirement information is mapped to the selection/deselection and parameterizing of one or more suitable feature(s) (feature assignment).

According to a preferred embodiment of the inventive method, a plurality of items of platform information is supplied, wherein one item of platform information of the plurality of items of platform information represents one vehicle platform respectively, wherein the solution information is ascertained using the plurality of items of platform information on the basis of the requirement information.

This represents a particularly expedient embodiment in the field of track-bound vehicles, in which, as a rule, a vehicle manufacturer has a plurality of vehicle platforms available. The vehicle platforms with their features accordingly span a solution space of the possible solutions in which the solution information is found (in this sense the solution information can be, for example, a vector whose entries are vehicle features).

It is possible that all features are met by the vehicle solution which is represented by the solution information. In this case, the vehicle solution can be delivered as a proposal in the framework of the invitation for bids by the vehicle manufacturer. The solution information is accordingly a technical representation of the proposal which the vehicle manufacturer delivers in the framework of the invitation for bids.

For the case where a requirement is not met by the vehicle solution, the requirement information has at least one requirement which is not met by the vehicle solution. This can be due to the fact, for example, that the vehicle solution does not have a suitable feature which could be selected in order to meet the requirement. According to a preferred embodiment of the method, a feature candidate is generated in this case, which is provided for meeting the at least one requirement which has not been met.

Preferably, the feature candidate serves in the subsequent development of the vehicle solution as the basis for a specific feature which is to be developed and by which the requirement is met. The ascertained solution information accordingly represents a first iteration in which feature candidates can be replaced by specific features in a second iteration.

The feature candidate accordingly has the advantage that targeted planning of the subsequent development of the vehicle platform is enabled. In addition, the feature candidate can form a suitable basis for planning the development of future vehicle platforms of the vehicle manufacturer.

In a further preferred embodiment of the inventive method, the vehicle solution has at least one feature which has to be changed in order to meet a requirement. In this case, identification information is generated which identifies that the feature has to be changed in a subsequent development of the vehicle solution. The solution information accordingly represents a first iteration, with the identified features being processed in a second iteration.

When the identified feature is changed, the feature is, for example, redeveloped or expanded or adjusted.

The difference between the requirement information and the solution information can be recognized and evaluated by the feature candidates and items of identification information described above.

In a further preferred embodiment, the first supply facility is operated by a vehicle customer which invites bids for a configured track-bound vehicle.

The vehicle customer is, for example, a vehicle operator and/or an operator of a transportation system for track-bound vehicles. The vehicle customer plans the acquisition of a configured track-bound vehicle and therefore invites bids for this for the awarding of a contract.

According to a further preferred embodiment, the track-bound vehicle is a rail vehicle.

The rail vehicle is, for example, a high-speed, long-distance public transport train or a regional train or a light rail system, a tram or a subway train for local public transport. The rail vehicle is, for example, a multiple unit. Alternatively, the rail vehicle is, for example, a freight train. The rail vehicle can be a locomotive, an individual car, a consist (composed of a plurality of permanently linked-together cars) and/or a vehicle combination (composed of mechanically- and/or virtually-/data-linked vehicles).

The object mentioned in the introduction is also achieved by a manufacturing method for manufacturing a track-bound vehicle. In the manufacturing method, the vehicle to be manufactured is technically configured according to the method described above.

The object mentioned in the introduction is also achieved by a computer program. The computer program comprises commands which, when the program is executed by a computing facility, prompt the computing facility to carry out the method of the type described above. The invention also relates to a computer program product with a computer program of this kind. The computing facility is preferably, at least in part, a computing facility of an onshore facility.

The object mentioned in the introduction is also achieved by a supply apparatus for the computer program of the type described above, wherein the supply apparatus stores and/or supplies the computer program. The supply apparatus is, for example, a memory unit which stores and/or supplies the computer program. Alternatively or in addition, the supply apparatus is, for example, a network service, a computer system, a server system, in particular a distributed, for example Cloud-based computer system and/or virtual computer system, which stores and/or supplies the computer program product preferably in the form of a data stream.

The supply is in the form of a program data block as a file, in particular as a download file, or as a data stream, in particular as a download data stream, of the computer program. However, this supply can also take place, for example, as a partial download which is composed of a plurality of parts. A computer program of this kind is read into a system, for example by using the supply apparatus, so the inventive method is carried out on a computer.

The object mentioned in the introduction is also achieved by an ascertaining facility for the technical configuration of a track-bound vehicle. The ascertaining facility comprises a first receiving facility which is configured to receive requirement information which represents requirements placed on a desired track-bound vehicle. The ascertaining facility also comprises a second receiving facility which is configured to receive platform information which represents features of a vehicle platform. The ascertaining facility also comprises a computing facility which is configured to ascertain solution information, which represents a vehicle solution in order to at least partially meet the requirements, wherein the computing facility is configured to ascertain the solution information using the platform information on the basis of the requirement information.

The object mentioned in the introduction is also achieved by a system for the technical configuration of a track-bound vehicle. The system comprises a first supply facility which is configured to supply requirement information which represents requirements placed on a desired track-bound vehicle. The system also comprises a second supply facility which is configured to supply platform information which represents features of a vehicle platform. The system also comprises an ascertaining facility which is configured to ascertain solution information, which represents a vehicle solution in order to at least partially meet the requirements, wherein the solution information can be ascertained using the platform information.

On the subject of advantages, embodiments and design details of the inventive manufacturing method, the inventive computer program, the inventive supply apparatus, the inventive ascertaining facility and the inventive system, reference can be made to the above description relating to the corresponding method features of the inventive method.

Exemplary embodiments of the invention will be explained using the drawings, in which:

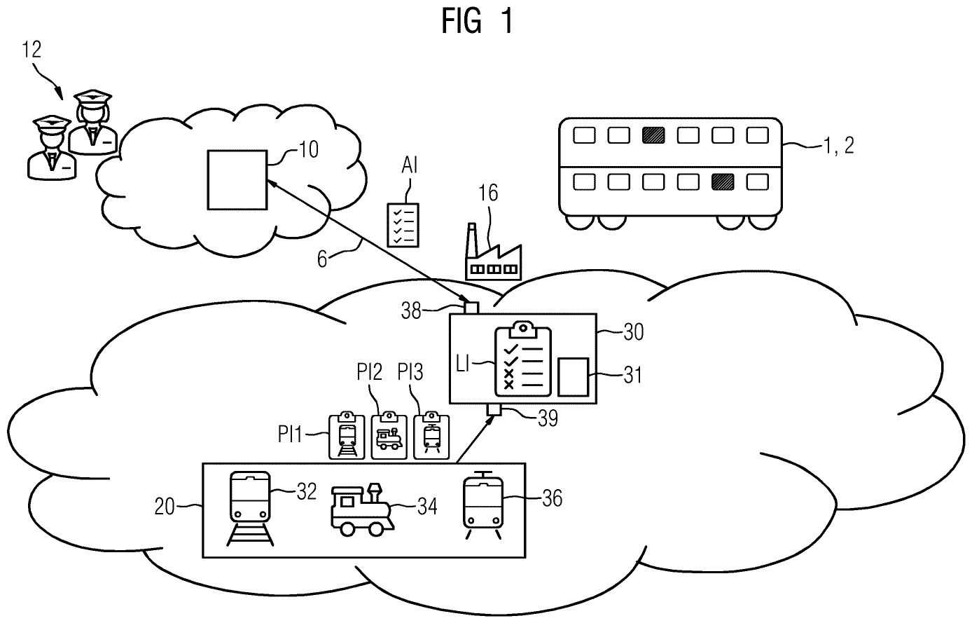

FIG. 1 schematically shows the construction of an exemplary embodiment of an inventive system and an inventive ascertaining facility and

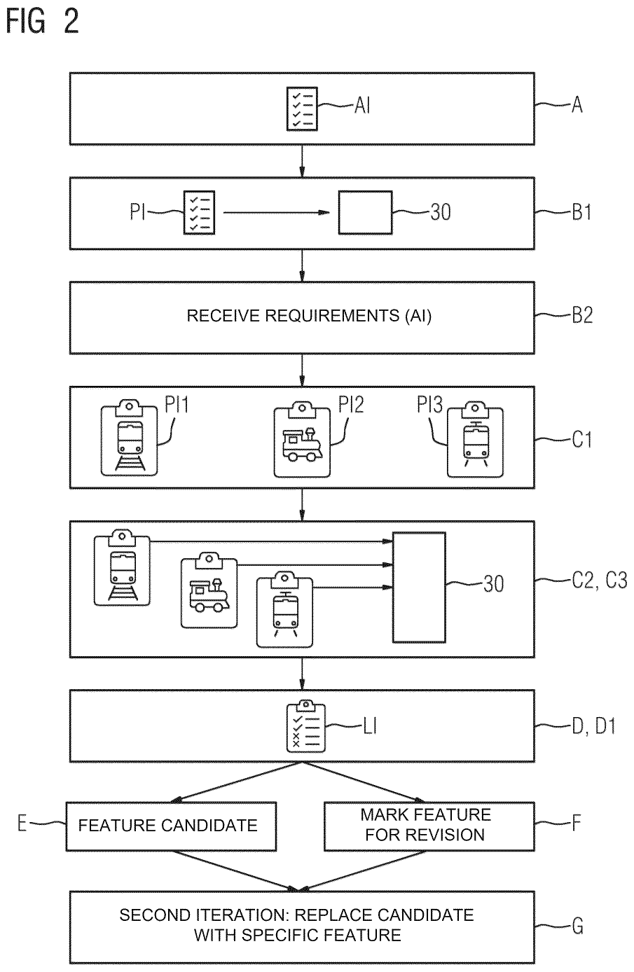

FIG. 2 schematically shows the sequence of an exemplary embodiment of an inventive method.

FIG. 1 shows a system for the configuration of a track-bound vehicle 1. The track-bound vehicle is a rail vehicle 2.

The system has a first supply facility 10 which is operated by a vehicle customer 12. The vehicle customer 12 is, for example, the operator of a rail transportation system. For this system, the vehicle customer 12 desires the track-bound vehicle 1 which is to be proposed by a vehicle manufacturer 16 in the framework of an invitation for bids for the awarding of a contract to develop the desired track-bound vehicle 1.

The system also has a second supply facility 20 and an ascertaining facility 30, which are operated by the vehicle manufacturer 16. The ascertaining facility 30 comprises a computing facility 31 which is configured to execute a computer program.

FIG. 2 schematically shows the sequence of an exemplary embodiment of the inventive method.

In a method step A, requirement information AI is generated by means of the first supply facility 10. The requirement information AI represents requirements placed on a desired track-bound vehicle. In particular, the requirement information AI relates to requirements which are specified in the framework of an invitation for bids for the awarding of a contract by the vehicle customer 12. In response to the invitation for bids, the vehicle manufacturer 16 can prepare a proposal on the basis of the requirements.

The requirement information AI is supplied in a method step B1 in that it is sent to the ascertaining facility 30 of the vehicle manufacturer 16 via the World Wide Web. In a method step B2, the requirement information AI is received by means of a first receiving facility 38 of the ascertaining facility 30.

In a method step C1, a plurality of items of platform information PI1, PI2, PI3 is generated using a plurality of existing vehicle platforms 32, 34, 36 of the vehicle manufacturer 16 and in a method step C2, is supplied to the ascertaining facility 30 by means of the second supply facility 20. The plurality of items of platform information PI1, PI2, PI3 is received in a method step C3 by means of a second receiving facility 39 of the ascertaining facility 30. Each item of platform information PI1, PI2 or PI3 of the plurality of items of platform information PI1, PI2, PI 3 represents features of a respective vehicle platform 32, 34 or 36 of the plurality of vehicle platforms 32, 34, 36.

The plurality of items of platform information PI1, PI2, PI3 is received in a method step C3 by means of a second receiving facility 39 of the ascertaining facility 30.

In a method step D, solution information LI is ascertained by means of the ascertaining facility 30, which information represents a vehicle solution which at least partially meets the requirements. The solution information LI is generated, for example in a method step D1, by configuration of selectable and/or parameterizable features of one of the vehicle platforms 32, 34 or 36.

Different cases can occur in this connection:

It is possible that all features are met by the vehicle solution which is represented by the solution information LI. In this case, the vehicle solution can be delivered by the vehicle manufacturer 16 as a proposal in the framework of an invitation for bids. The solution information is accordingly a technical representation of the proposal which the vehicle manufacturer 16 submits in the framework of the invitation for bids.

It is also possible that a requirement is not met by the vehicle solution. In this case, a feature candidate is generated in a method step E, which candidate is provided for meeting the requirement. In the subsequent development, the feature candidate serves as a basis for a specific feature that is to be developed and by which the requirement is met. The ascertained solution information accordingly represents a first iteration in which feature candidates can be replaced by specific features in a second iteration in a method step G.

Further, it is possible that the vehicle solution has at least one feature which has to be changed in order to meet a requirement. In this case, identification information is generated in a method step F and assigned to the feature. The identification information identifies that the feature has to be changed in a subsequent development of the vehicle solution. In the subsequent development it is decided whether and, if so, how this change is achieved. The solution information accordingly represents a first iteration, with the identified features being processed in a second iteration in a method step G.

Although the invention has been illustrated and described in detail by the preferred exemplary embodiment, it is nevertheless not limited by the disclosed examples and a person skilled in the art can derive other variations here from without departing from the scope of the invention.

1-12. (canceled)

13. A method for a technical configuration of a track-bound vehicle, the method comprising:
supplying requirement information, which represents requirements placed on a desired track-bound vehicle;
supplying platform information, which represents features of a vehicle platform; and
ascertaining solution information, which represents a vehicle solution in order to at least partially meet the requirements, by using the platform information on a basis of the requirement information.

14. The method according to claim 13, which comprises generating the solution information by configuring at least one of selectable or parameterizable features of the vehicle platform.

15. The method according to claim 13, which comprises:
supplying a plurality of items of platform information, with one item of platform information of the plurality of items of platform information respectively representing features of a vehicle platform; and
ascertaining the solution information by using the plurality of items of platform information on the basis of the requirement information.

16. The method according to claim 13, which comprises,
when the requirement information represents at least one requirement which is not met by the vehicle solution,
generating a feature candidate for meeting the at least one requirement which has not been met.

17. The method according to claim 13, which comprises,
when the vehicle solution has at least one feature which has to be changed in order to meet a requirement,
generating identification information which identifies that the at least one feature has to be changed when a further vehicle solution is ascertained.

18. The method according to claim 13, which comprises supplying the requirement information via a first supply facility that is operated by a vehicle customer who invites bids for a configured track-bound vehicle.

19. The method according to claim 13, wherein the track-bound vehicle is a rail vehicle.

20. The method according to claim 19, wherein the track-bound vehicle is a multiple unit rail vehicle.

21. A manufacturing method for manufacturing a track-bound vehicle, the method which comprises technically configuring the vehicle to be produced by performing the method according to claim 13.

22. A non-transitory computer program, comprising commands which, when the program is executed by a computing facility, prompt the computing facility to carry out the method according to claim 13.

23. An apparatus for storing and supplying a computer program in non-transitory form, configured to store and supply a computer program with commands which, when the program is executed by a computing facility, prompt the computing facility to carry out the method according to claim 13.

24. A facility for ascertaining a technical configuration of a track-bound vehicle, the facility comprising:
a first receiving device configured to receive requirement information which represents requirements placed on a desired track-bound vehicle;
a second receiving facility configured to receive platform information which represents features of a vehicle platform; and
a computing device configured to ascertain solution information which represents a vehicle solution that meets, at least in part, the requirements placed on the desired track-bound vehicle, said computing device being configured to ascertain the solution information using the platform information on a basis of the requirement information.

25. A system for a technical configuration of a track-bound vehicle, the system comprising:
a first supply facility which is configured to supply requirement information which represents requirements to be met by a desired track-bound vehicle;
a second supply facility which is configured to supply platform information which represents features of a vehicle platform; and
an ascertaining facility which is configured to ascertain solution information which represents a vehicle solution that meets, at least in part, the requirements to be met by the desired track-bound vehicle, with the solution information being ascertained using the platform information on a basis of the requirement information received by the first supply facility.
